(19) United States
(12) Patent Application Publication
(10) Pub. No.: US 2007/0190201 A1
(43) Pub. Date: Aug. 16, 2007

(54) Extruder die assembly, extruder, and method

(76) Inventor: Jere E. Irwin, Yakima, WA (US)

Correspondence Address: WELLS ST. JOHN P.S., 601 W. FIRST AVENUE, SUITE 1300, SPOKANE, WA, 99201, US

(21) Appl. No.: 11/705,854

(22) Filed: Feb. 13, 2007

Related U.S. Application Data
(60) Provisional application No. 60/773,137, filed on Feb. 13, 2006.

(51) Int. Cl. B29C 47/12

(52) U.S. Cl. 425/466; 425/461

(57) ABSTRACT

An extruder die assembly is provided having a die support body, an outer die member, an inner die member, and an actuator. The outer die member has an outer die lip. The outer die member is supported by the die support body. The inner die member has an inner die lip spaced from the outer die lip in order to provide an annular die gap therebetween. The inner die member is supported for movement by the die support body. The actuator is coupled with the inner die member to move the inner die member relative to the outer die member. A method is also provided.

### RELATED PATENT DATA

This application claims priority from U.S. Provisional Patent Application Ser. No. 60/773,137, which was filed Feb. 13, 2006, and which is incorporated by reference herein.

### TECHNICAL FIELD

The present invention pertains to polymer foam sheet formation. More particularly, the present invention relates to extruder dies and actuator systems for adjusting annular die gaps for extruder dies and methods.

### BACKGROUND OF THE INVENTION

The field of extrusion, and more particularly, the field of thermoplastic foam extrusion, entails many techniques that are utilized in order to generate a uniform thickness product having desirable surface finish features and appropriate dimensional qualities. The ability to adjust an annular die gap to clean the gap of an extruder die assembly while the die assembly is being used is a desirable feature.

FIG. 1 illustrates one construction for an extruder die assembly that was implemented in a single commercial device as well as a single test device in the mid-1980s by the present Applicant in an attempt to improve the surface finish and dimensional qualities when forming polymer foam sheet from an extruder die.

As shown in FIG. 1, an annular extruder die assembly 10 is shown mounted to the downstream end of an extruder 12 (similar to extruder 100 shown below with reference to FIG. 2). Die assembly 10 includes a barrel/spider/die assembly 16 comprising a barrel 18, a spider 20, and a die 22 that are joined together and mounted onto an end 14 of extruder 12. A barrel heater spacer 24 is provided about barrel 18. Similarly, a spider clamp ring 26 mounts spider 20 onto barrel 18. A spider heater spacer 28 is mounted about spider 20. A die lip clamp ring 30 mounts die 22 onto spider 20. Additionally, a sheet metal shell 32 forms an enclosure about spacer 24, ring 26, spacer 28, and ring 30. In this manner, a cooling air passage is provided within shell 32 from a source of cooling air 36 that passes through spacer 24, ring 26, spacer 28, and ring 30 where the flow of air exits adjacent an air ring 34. Air ring 34 provides an annular flow of cooling air onto an outer surface of a tubular film of extruded foam material that is being ejected from an annular extruder die.

Spider 20 includes a spider core 38 configured to support a die shaft 42 downstream and coaxially with respect to a bore 40. Spider core 38 is supported by a single radial arm 39 within bore 40. Die shaft 42 mounts onto core 38 via a male threaded portion 44 that is received into a complementary female threaded portion 46 of core 38. An outer die lip collar 48 is seated onto a cylindrical mounting post 50 of shaft 42 via a washer 52 and a jam nut 54. Jam nut 54 is manually rotated (or loosened) with a wrench in order to separate collar 48 from an inner die lip 62 when it is necessary to enlarge a die gap between the inner die lip 62 and an outer die lip 64 of collar 48 to clean particles from the die gap.

According to the prior art construction of die assembly 10 of FIG. 1, a plurality of die lip adjuster brackets 56 are mounted in equally circumferentially spaced-apart positions about die 22 via individual threaded adjuster bolts 58. Bolts 58 are each received into a threaded bore 60 in die 22. Accordingly, it is necessary to machine bores 60 into die 22 (which is typically made from hardened steel) at various circumferentially spaced-apart locations thereabout. Bolt 58 is tightened into threaded engagement within bore 60 in order to drive Z-shaped bracket 56 down a frustoconically shaped slope face of die 22 which drives a finger of bracket 56 downwardly and forward into engagement along a radial surface of inner die lip 62. Accordingly, a die gap dimension between lips 62 and 64 can be adjusted at various circumferential locations thereabout by adjusting each respective bolt 58 for each bracket 56 at each circumferential location about die 22.

The actuation of jam nut 54 requires manual rotation by an operator using a wrench. In order to reach nut 54, the extruder die cannot be in operation as nut 54 is typically received in engagement with a collar of a cooling mandrel. Hence, an operator cannot access nut 54 during operation of an extruder. Accordingly, improvements are needed in order to enable an operator to further open an annular die gap in an extruder die assembly in order to clean out particles that are getting caught in the annular die gap while the extruder die assembly is in operation. It has been found through experience that improvements are still needed in order to enable quick and easy cleaning of an annular die gap while an extruder die assembly is in use.

Feedback from the above-described prior art effort identified the need for further improvements in order to further enhance the surface finish and dimensional qualities of a polymer foam sheet being formed by an extruder die. Accordingly, the Applicant has implemented further improvements which are described below in the Detailed Description.

### SUMMARY OF THE INVENTION

An extruder is provided with an extruder die assembly that has a pair of cooperating die members providing an annular die gap therebetween in which one of the die members can be moved relative to the other die member while the extruder is in operation and is extruding plastic foam product from the annular die gap. Such adjustment between the die members is desirable, for example, when it is necessary to clean particles from within the extruder die gap which have become lodged therein due to contamination of the product being extruded between the die members.

According to one aspect, an extruder die assembly is provided having a die support body, an outer die member, an inner die member, and an actuator. The outer die member has an outer die lip. The outer die member is supported by the die support body. The inner die member has an inner die lip spaced from the outer die lip in order to provide an annular die gap therebetween. The inner die member is supported for movement by the die support body. The actuator is coupled with the inner die member to move the inner die member relative to the outer die member.

According to another aspect, a method of extruding thermoplastic foam is provided. The method includes: providing a stationary outer die, a movable inner die configured to cooperate with the outer die to provide an annular die gap therebetween, and an actuator for moving the inner die relative to the outer die; moving the actuator to a first position with the inner die positioned relative to the outer die to provide the die gap in a sheet forming operating position; and responsive to a need to clean the die gap, moving the actuator to a second position further away from the outer die to provide the die gap in a die gap cleaning position.

### BRIEF DESCRIPTION OF THE DRAWINGS

Preferred embodiments of the invention are described below with reference to the following accompanying drawings.

FIG. 1 is a vertical view of a prior art annular extruder die assembly.

FIG. 2 is a perspective, simplified view of an extruder with an annular extruder die assembly of the present invention.

FIG. 3 is an enlarged and simplified perspective view of a cooling mandrel over which a tubular film of extruded foam material is drawn and dimensionally stabilized as well as severed into two sheets.

FIG. 4 is an enlarged perspective view of a die assembly according to the present invention.

FIG. 5 is a vertical centerline sectional view taken in the direction of arrow 5 of FIG. 4 and further illustrating the die assembly.

FIG. 6 is a centerline sectional view taken in the direction of arrow 6 of FIG. 4 and further illustrating the die assembly.

FIG. 7 is an enlarged sectional view taken from the encircled region 7 of FIG. 6 and depicting the annular die gap in a minimally open, operating position.

FIG. 8 is an enlarged sectional view corresponding with that shown in FIG. 7, but depicting the annular die gap in a fully open, cleaning position.

FIG. 9 is a centerline sectional view taken in a direction that corresponds with arrow 6 of FIG. 4, but showing an alternatively constructed die assembly according to another aspect of the present invention.

FIG. 10 is an enlarged sectional view taken from the encircled region 10 of FIG. 9 and depicting the angular die gap in a minimally open, operating position.

FIG. 11 is an enlarged sectional view corresponding with that shown in FIG. 10, but depicting the angular die gap in a fully open, cleaning position.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

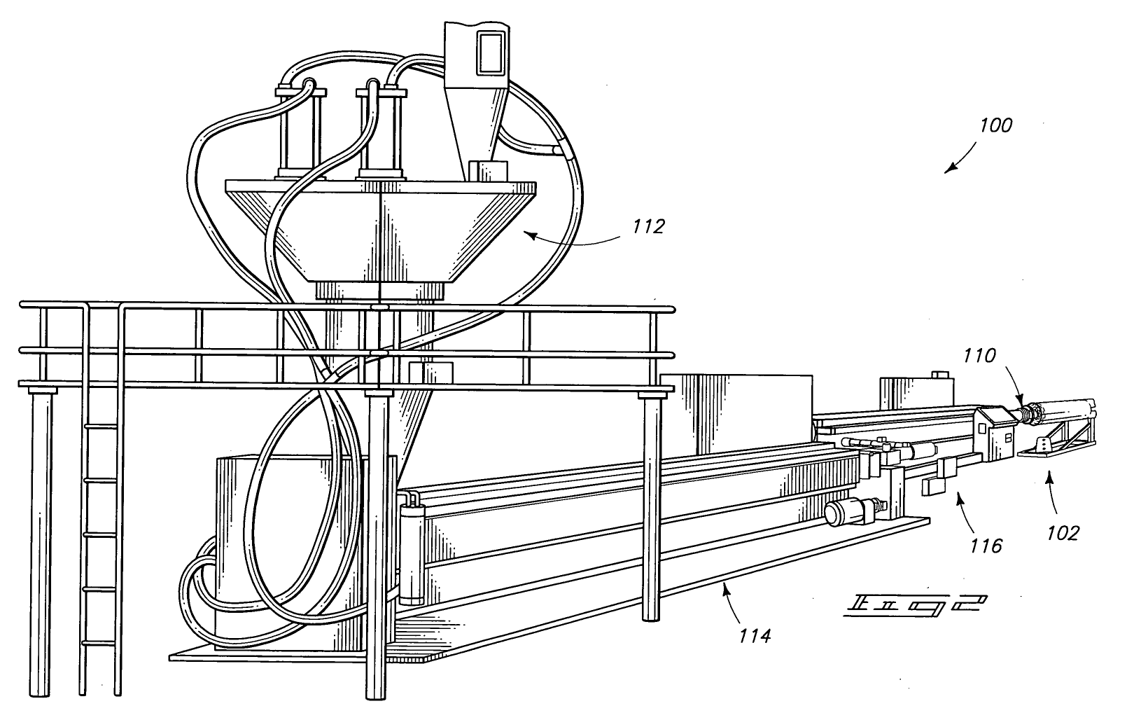

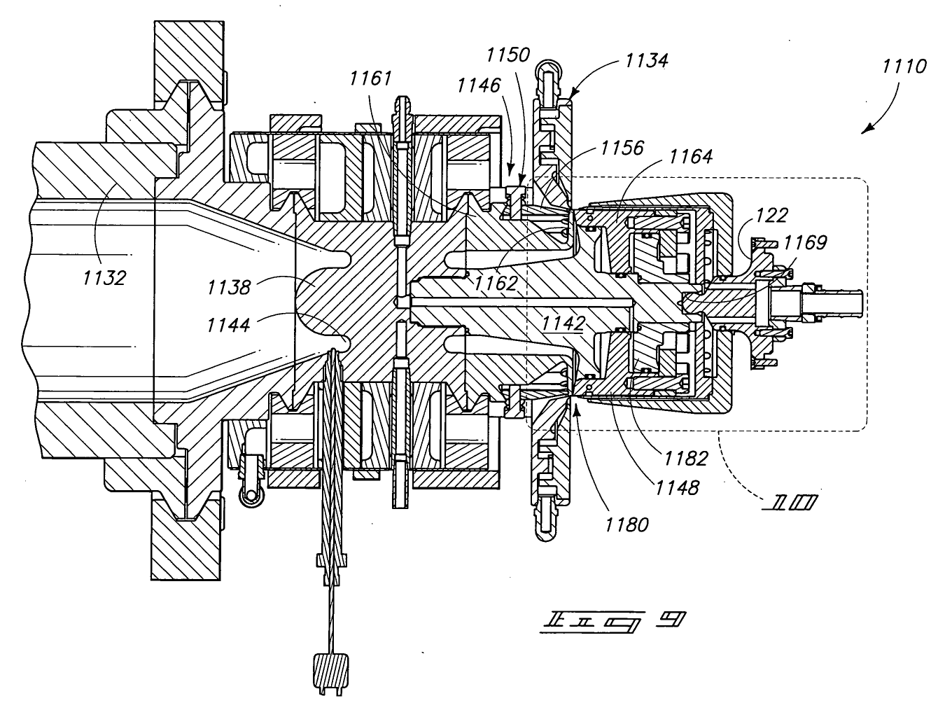

Reference will now be made to preferred embodiments of Applicant's invention comprising an annular extruder die assembly identified by reference numeral 110 (see FIGS. 2-8) and reference numeral 1110 (see FIGS. 9-11) having a movable die member, or die lip. While the invention is described by way of preferred embodiments, it is understood that the description is not intended to limit the invention to such embodiments, but is intended to cover alternatives, equivalents, and modifications which may be broader than the embodiments, but which are included within the scope of the appended claims.

In an effort to prevent obscuring the invention at hand, only details germane to implementing the invention will be described in great detail, with presently understood peripheral details being incorporated by reference, as needed, as being presently understood in the art.

FIG. 2 illustrates a thermoplastic foam extrusion assembly typically referred to as an extruder 100 having the provision of an annular extruder die assembly 110 pursuant to the present invention. Extruder 100 is configured to produce an expandable polymer plastic, such as a thermoplastic foam extrusion, in a finished or semi-finished product. One suitable thermoplastic foam extrusion comprises a polystyrene sheet. Annular extrusion die assembly 110 generates a tube of such thermoplastic foam extrusion which is delivered over a cooling mandrel 102 where the tube is cut into an upper and lower sheet and which is then subsequently rolled onto storage rolls (not shown).

It is understood that, in addition to polystyrene, other forms of thermoplastic extrusion can be generated using the annular extrusion die assembly of the present invention. For example, polyethylene (PE), PET, polypropylene, or other similar thermoplastics, including expandable or foaming polymer thermoplastics or other materials, may be generated using the annular die assembly of the present invention.

By way of example, extruder 100 is depicted as a two-stage extruder having a hopper 112 configured to receive material, particularly in the form of pellets, small beads, cubes, blocks, chunks, or flakes of material that is then melted within a melt region of a first stage 114 of extruder 100. A second stage 116 of extruder 100 is provided downstream of first stage 114 and is configured to provide a heat extraction region for the melted material. Further details for the construction of one suitable, two-stage extruder are disclosed in U.S. Pat. No. 6,432,337, herein incorporated by reference. However, the extruder can also be a single stage extruder, or a multiple stage extruder.

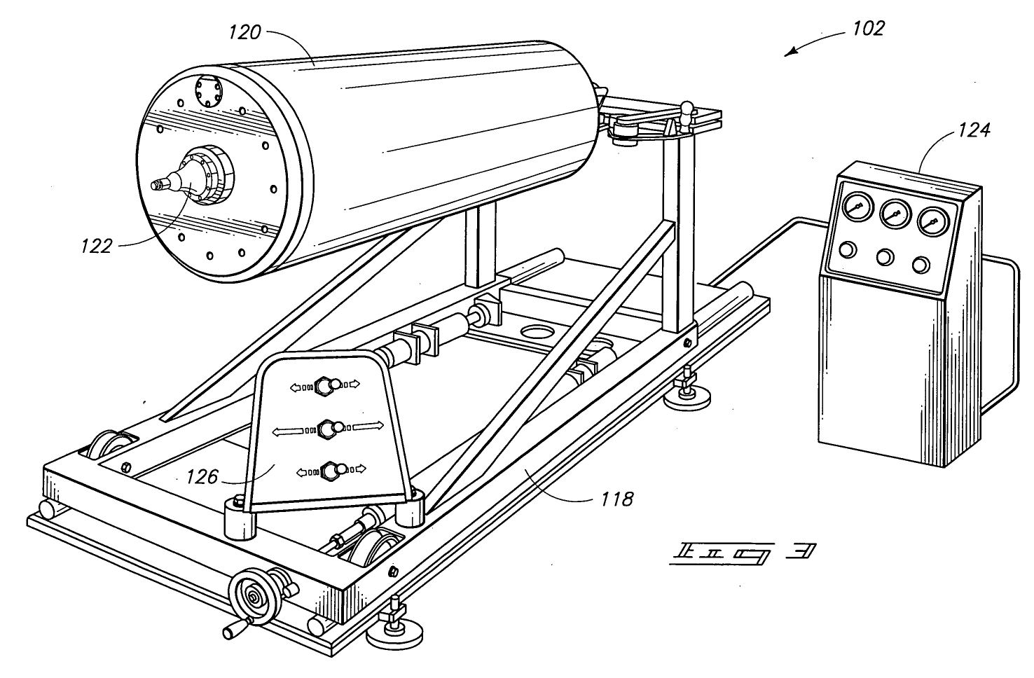

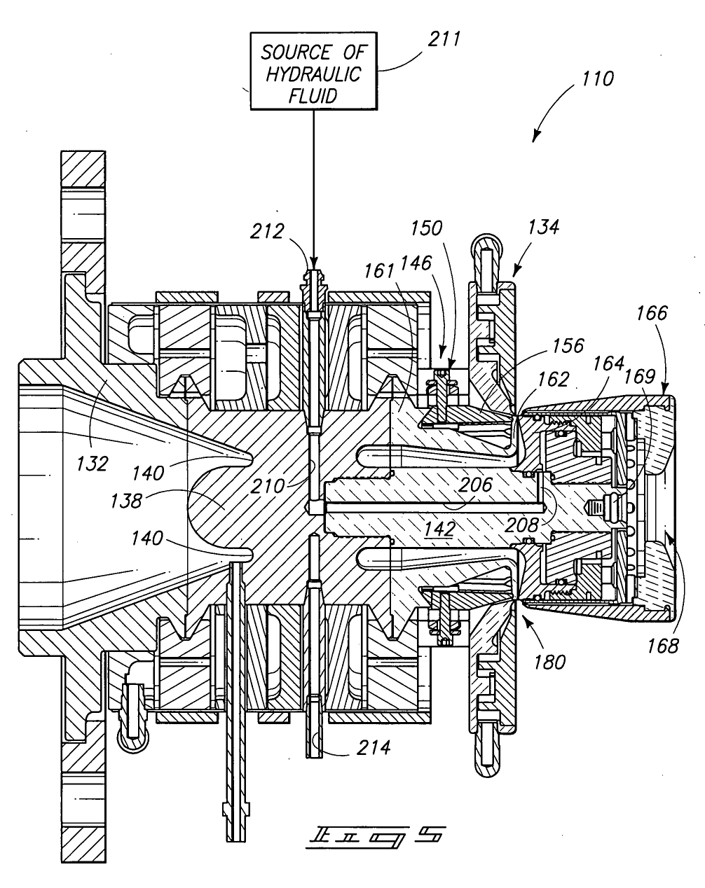

FIG. 3 illustrates one construction for a suitable cooling mandrel 102 that is positioned downstream of the annular extruder die assembly for stretching, sizing, and cooling a tube of extruded thermoplastic foam. Cooling mandrel 102 is also configured with a pair of knives to slit the tube of thermoplastic foam extrusion at a downstream end in order to generate a top and bottom sheet of such thermoplastic foam extrusion. Cooling mandrel 102 includes a frame 118, a drum 120, a post 122 that mates, and locks, with a complementary receiver 168 (see FIG. 5) provided at a downstream end of an annular extrusion die assembly, an electrical control box 124, a pneumatic control panel 126, and a plurality of adjustable air vents 128 that are configured to generate a flow of cooling air on an inner surface of a tubular thermoplastic extrusion being stretched over drum 120.

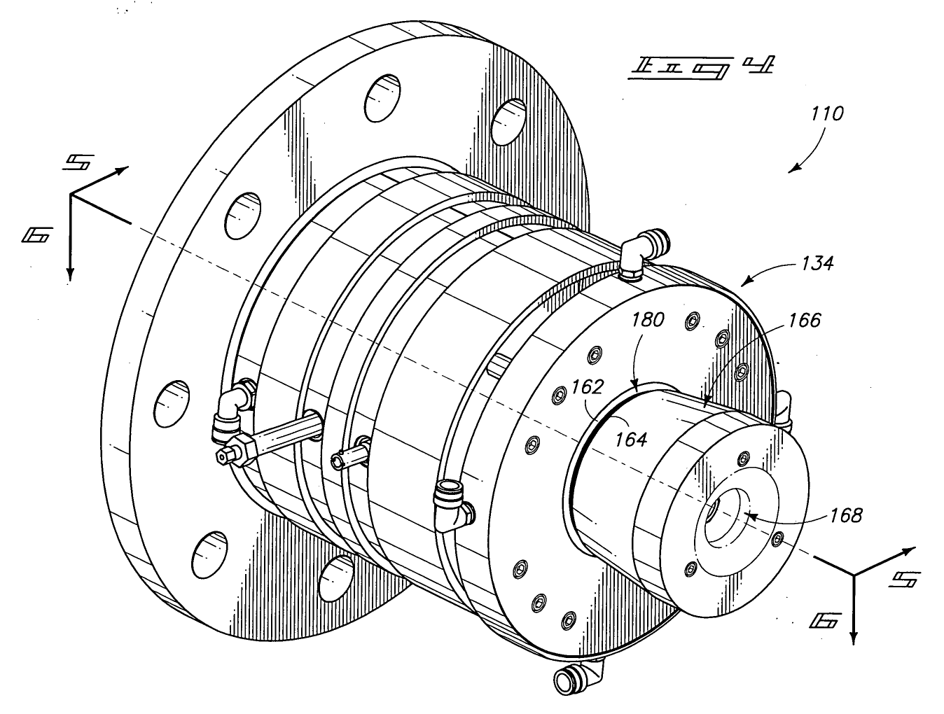

FIG. 4 illustrates the positioning of annular extruder die assembly 110 on the downstream end of an extruder 100. Die assembly 110 is provided downstream of a shell in which a barrel and a spider are provided. The spider coaxially supports a die shaft via a spider core coaxially within a bore. The spider core is supported via a plurality of spider arms that extend radially from the core. The die shaft extends downstream from the spider core. A cooling ring 134 is provided just upstream of an annular die gap 180 formed by an outer die lip 162 and an inner die lip 164. An inner die lip assembly 166 is provided downstream of gap 180. A mounting port assembly 168 is provided for mating with post 122 on mandrel 102 (see FIG. 3).

Die assembly 110 has a die lip adjustment apparatus that enhances the ability to control dimensional characteristics and surface finish in a tubular thermoplastic foam extrusion that is ejected therefrom, as shown in FIG. 5. More particularly, an adjuster support ring 150 extends circumferentially about a die body 161 to support a plurality of die lip adjuster paddles, or wedges, 156 that are circumferentially spaced apart in equi-distance and relation from each other about die body 161. Each adjuster paddle 156 can be adjusted via a threaded adjuster bolt 158 and a washer 160 to co-act against a respective ring member 152-154 of support ring 150 to locally deform an outer die lip 162 in relation to an inner die lip 164 of an inner die lip collar 148.

By tightening fastener 158 and raising a rear portion of paddle 156, outer die lip 162 is locally deformed towards inner die lip 164, which reduces the die gap locally therebetween. By monitoring the thickness of a tube of thermoplastic foam extrusion being generated via a corresponding annular die gap 180, individual paddles 156 can be adjusted at selected circumferential locations about annular die gap 180 in order to adjust die gap 180 to realize a more uniform and consistent thickness of material being generated therefrom. Paddle 156 applies lateral force to outer die lip 162 at a constant radial location which creates a constant length fulcrum arm. This leads to more controlled application of bending force onto die lip 162.

According to one construction, annular die gap 180 has a typical thickness (or width) between lips 162 and 164 of 0.021 inches. Also according to one construction, annular die gap 180 is constructed to have a diameter of 5.595 inches. However, it is understood that alternative dimensions and materials can also be utilized in constructing the various components of the die lip adjuster assembly and the annular extrusion die assembly.

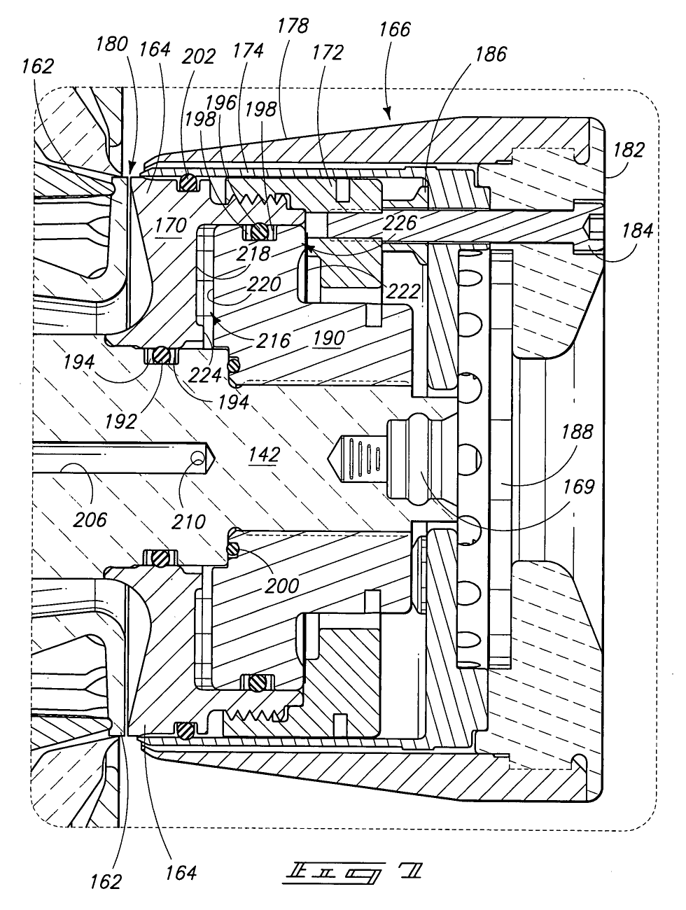

FIGS. 5-8 illustrate in greater detail the construction of annular extruder die assembly 110. More particularly, inner die lip 164 of extruder die assembly 110 is moved relative to an outer die lip 162, which is held stationary, using an actuator, such as a source of hydraulic fluid 211. Source 211 comprises a hydraulic pump, a hydraulic reservoir, valves, and a valve control system. Alternatively, outer die lip 162 could be moved while inner die lip 164 is stationary. Furthermore, both inner die lip 164 and outer die lip 162 could be moved in order to open up the annular die gap 180 in order to eject contaminants, or particles that are caught or lodged within the annular die gap 180. More particularly, an actuator is provided for moving inner die lip 164 relative to outer die lip 162. According to one construction, the actuator is provided by a hydraulic actuator, such as a source 211 of hydraulic fluid that communicates via hydraulic connector 212 via a radial port 210 to deliver hydraulic fluid under pressure via axial port 206 and radial port 208 to deliver pressurized hydraulic fluid into an expansible chamber 216 (see FIG. 7) to drive inner die lip 164 towards outer die lip 162 so as to provide a minimal dimension annular die gap. By reducing the pressure of the hydraulic fluid, or releasing the hydraulic fluid pressure, the pressure of fluid product being extruded through die gap 180 will push die lip 164 away from die lip 162 and thereby open up the annular die gap, enabling contaminants or particles to be ejected through gap 180.

In normal operation, a hydraulic valve is switched off and the hydraulic pressure is released such that die lip 164 will move away from die lip 162 for a short period of time. Subsequent to such action, the hydraulic fluid is resupplied via port 210 into the expansible chamber in order to resize the die gap such that inner die lip 164 moves towards the closest position relative to outer die lip 162.

Accordingly, extruder die assembly 110 has an adjustable, annular die gap 180 that is provided downstream of a cooling air ring 134. Assembly 110 is mounted onto an extruder, such as extruder 100 (of FIG. 2). Source 211 enables dynamic movement of die lip 164 relative to die lip 162 while extruding product between such die lips 162 and 164. Additionally, annular die gap 180 can be further adjusted to provide a desired gap along the entire circumference by positioning, through bending, outer die lip 162 using an adjustable paddle system comprising a die lip adjustment apparatus 146. Apparatus 146 is typically adjusted when the extruder is not operating. However, it is also possible to adjust the positioning of outer die lip 162 while the extruder is operating.

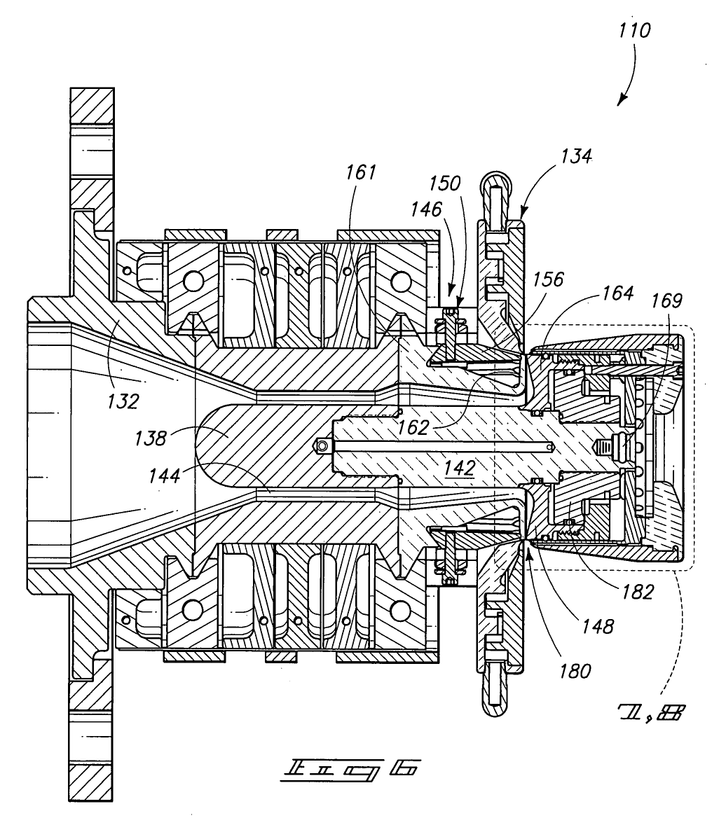

FIG. 6 further illustrates features of the adjustable annular die gap 180 on extruder die assembly 110. Outer die lip 162 is adjusted using a three-piece adjuster support ring 150. A plurality of circumferentially spaced-apart die lip adjuster paddles 156 are supported about ring 150. Adjuster paddles 156 co-act against a sloped rear face on die body 161 to locally deform outer die lip 162 toward inner die lip 164 in response to tightening of individual threaded adjuster bolts.

In operation, molten plastic is delivered in a downstream direction through an extruder and into a barrel 132 where it passes into a gap provided by a spider core 138 that is supported coaxially within a cylindrical bore 144. Spider core 138 is supported coaxially within bore 144 via a pair of spider arms 140 (see FIG. 5). Molten plastic is then delivered around a die shaft 142 before exiting through an annular die gap 180 provided between outer die lip 162 and inner die lip 164. Gap 180 is provided adjacent and downstream of cooling air ring 134. Individual paddles 156 are adjusted after observing the thickness and uniformity of foam sheet product that exits gap 180 in order to tailor the local gap dimension in order to achieve a sheet product with more uniform thickness. In the event material (or contaminants) needs to be cleaned from gap 180, inner die lip 164 is moved away from outer die lip 162 by actuating die lip collar 148 away from outer die lip 162. Collar 148 moves relative to end collar 182.

FIG. 5 further depicts construction of annular extruder die assembly 110 with a pair of spider arms 140 shown supporting spider core 138 relative to barrel 132. Die shaft 142 is shown mounted to a downstream end of spider core 138. Inner die lip 164 is supported for axial movement from die shaft 142 to enable opening of die gap 180 between lips 162 and 164. Paddles 156 of die lip adjustment apparatus 146 are assembled onto adjuster support ring 150, after which cooling air ring 134 is assembled thereabout.

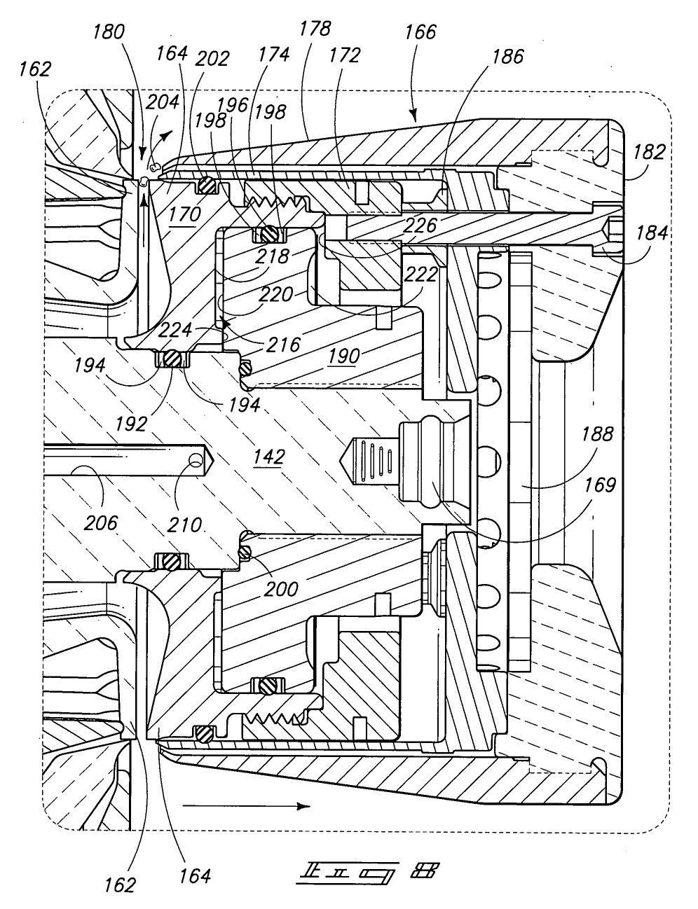

With respect to the adjustment mechanism that moves inner die lip 164, FIGS. 7 and 8 further illustrate the manner in which an apparatus is used to move inner die lip 164 relative outer die lip 162, particularly during operation of the extruder. More particularly, a source of working fluid, such as hydraulic fluid, is controllably delivered into expansible working chamber 216 via axial port 206 and radial port 210. Under normal operating conditions, extruder die lips 162 and 164 are held in a minimally close position while product is being extruded therefrom via gap 180 and hydraulic fluid pressure is delivered into working chamber 216. Hydraulic fluid pushes apart hydraulic reaction surfaces 218 and 220 which causes inner die member 170 to move towards outer die lip 162. Inner die member 170 moves relative to a stationary support collar 190 that is threaded onto die shaft 142. An engagement surface 226 prevents inner die member 170 from contacting die lip 162, thereby defining a minimal dimension gap 180 between lips 162 and 164. Similarly, another engagement surface 224 on member 170 mates with support collar 190 (see FIG. 8) when inner die member 170 is moved to a maximal distance away from die lip 162, as shown in FIG. 8. Such condition occurs when the supply of hydraulic fluid is no longer forced into working chamber 216 and the pressure of product being extruded through die gap 180 forces inner die member 180 away from outer die lip 162, thereby enabling the passage of small particles and contaminants through and out of die gap 180.

As shown in FIGS. 7 and 8, inner die lip 164 is provided on a radially outer portion of inner die member 170. Similarly, outer die lip 162 is provided on an outer die member, or body 161 (see FIG. 5). Inner die member 170 is affixed together via threads to a cylindrical collar 172. A plurality of threaded fasteners, or bolts 184 are then used to secure an inner air delivery collar and an end collar onto member 170 and collar 172. An outer air deliver collar 178 is threaded and secured onto end collar 182. As shown in FIGS. 7 and 8, a spacer 186 is provided about each bolt 184 so as to properly space apart inner air delivery collar 174 and collar 172.

As shown in FIGS. 7 and 8, an annular gap is provided between collars 174 and 178 for supplying cooling air to an inner surface of an annular sheet of product being extruded from the extruder dies. Such cooling air is delivered via an inner air manifold 188 for radially delivery to such gap and exits adjacent inner die lip 164. A supply of cooling air is also provided to the outer surface of the annular sheet from cooling air ring 134 (see FIG. 6).

Sliding seals are provided along inner die member 170 by O-ring seals 192 and 196. O-ring seal 192 is provided between member 170 and die shaft 142 along with a pair of Teflon® back-up rings 194 provided in each side of O-ring seal 192. Similarly, O-ring seal 196 is provided between member 170 and collar 190 along with a pair of Teflon® back-up rings 198 that are provided on each side of O-ring seal 196. According to one construction, O-ring seals 192 and 196 are each constructed from 90 Durometer Viton.

A pair of stationary seals are also provided. More particularly, an O-ring seal 200 is provided between die shaft 142 and collar 190. Likewise, a similar O-ring seal 202 is provided between inner die member 170 and inner air delivery collar 174. According to one construction, O-ring seals 200 and 202 are constructed from 70 Durometer Viton.

Additionally, one or more stainless steel washer-spaced shims 222 are provided between member 190 and engagement surface 226 of collar 172. According to one construction, shims are constructed having thicknesses, by way of example, of 4/1,000ths of an inch and 10/1,000ths of an inch. The provision and interchangeability of one or more of such shims 222 can be used to achieve a desired minimal-dimension die gap 180 while the extruder is in an operating condition as shown in FIG. 7.

FIG. 8 illustrates the movement of inner die member 170 away from die lip 162 when the actuator has been released. For example, the supply of hydraulic fluid is released (or the pressure is reduced) which causes member 170 to move away from outer die lip 162 and to open up die gap 180 to a maximal dimension in order clean particles or contaminants from die gap 180. Also shown in FIGS. 7 and 8, a female receiver 169 is provided for mating with post 122 of FIG. 3. According to one construction, post 122 comprises a ball-lock fastener that mates within receiver 169. Receiver 169 includes a conical coil spring for reacting against the post when received within receiver 169.

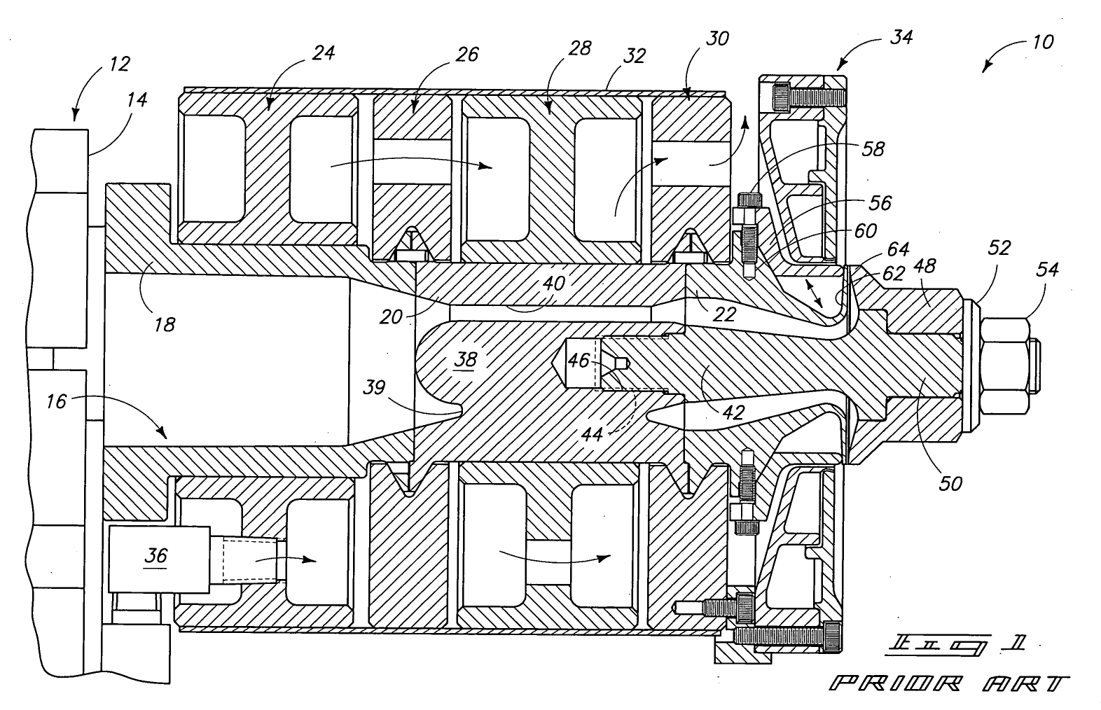

FIGS. 9-11 illustrate an alternative embodiment construction annular extruder die assembly 110 that includes component modifications that were made to improve manufacturing and assembly over the embodiment depicted in FIGS. 1-8. All component numbers for the embodiment of FIGS. 9-11 have been incremented by 1000 over the numbers for the embodiment of FIGS. 1-8 where similar components between the two embodiments are illustrated. Accordingly, the number identification of components and their description can be referenced by comparing the corresponding similar parts in the first embodiment and subtracting 1000 from the part number in the FIG. 9-11 embodiment. Attention will be focused in order to describe the components that have been modified significantly.

More particularly, inner die member 1170 is modified over member 170 (of FIGS. 5-8) in that in that die shaft 1142 extends outwardly to a greater radial extent than does die shaft 142 (of FIGS. 5-8). O-ring seals 1192, 1196, 1200 and 1202 have different sizes, but are otherwise similar to o-ring seals 192, 196, 200 and 202. O-ring seal 1193 functions together with O-ring seal 1192 to replace O-ring seal 192 (of FIGS. 6-9). Cylindrical collar 1172 also has a different geometry than does cylindrical collar 172.

Additionally, outer air delivery collar 1178 is made from a single piece, in contrast with outer air delivery collar 178 and end collar 182 (see FIG. 7) which are made from two pieces that join together. In operation, inner air manifold 1188 delivers cooling air in a manner similar to manifold 188 (of FIG. 7). A post 122 (see FIG. 3) is also shown received into female receiver 1169, although it was omitted in the corresponding receiver 169 (of FIG. 6).

Annular die gap 1180 is defined by the spacing between inner die lip 1164 and outer die lip 1162, similar to how gap 180 is defined by the spacing provided between lip 164 and 162 (of FIG. 7). Hydraulic fluid is delivered via ports 1206 and 1210 into expansible working chamber 1216 to act against reaction surfaces 1218 and 1220, similar to the delivery via ports 206 and 210 into chamber 216 to act against surfaces 218 and 220 (of FIG. 7).

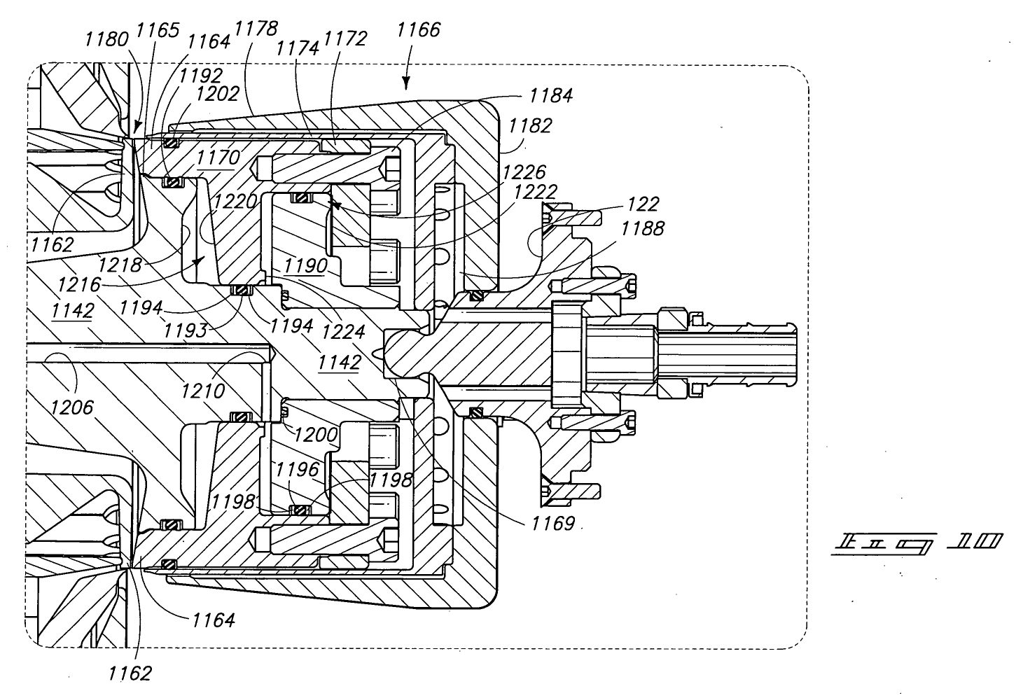

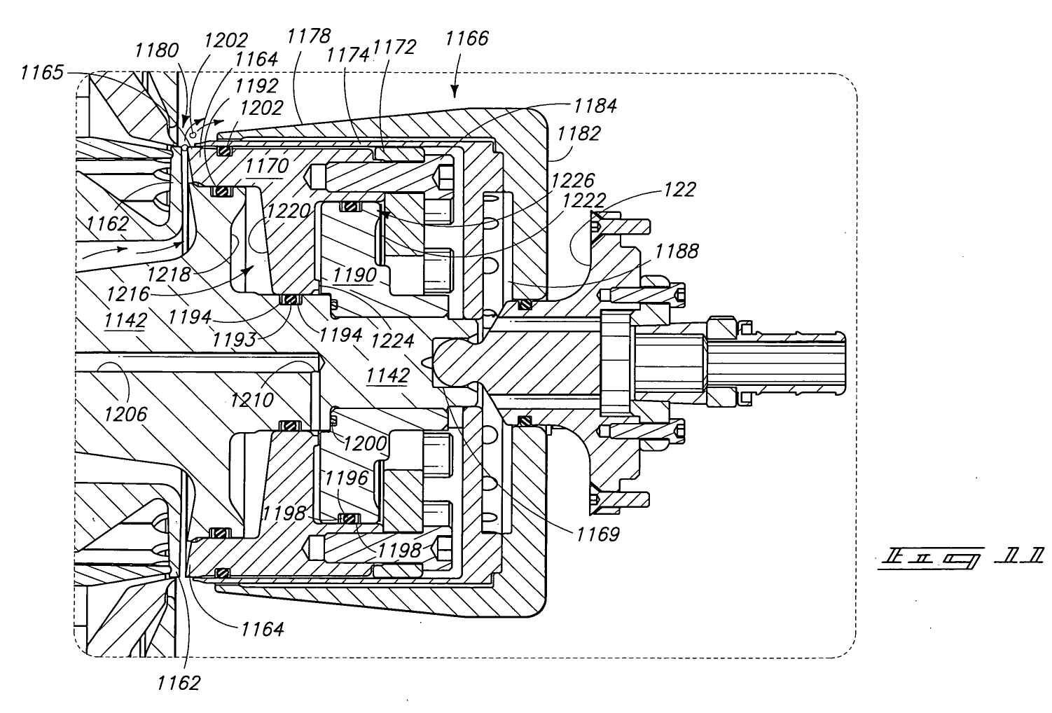

As shown in FIG. 10, die shaft 1142 terminates in a radial outer finger flange 1165 that limits to closing of inner die lip 1164 relative to outer die lip 1162. When cleaning gap 1180, inner die lip 1164 moves away from flange 1165 as shown in FIG. 11.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

The invention claimed is:

1. An extruder die assembly, comprising:
a die support body;
an outer die member having an outer die lip and supported by the die support body;
an inner die member having an inner die lip spaced from the outer die lip to provide an annular die gap therebetween, the inner die member supported for movement by the die support body; and
an actuator coupled with the inner die member to move the inner die member relative to the outer die member.

2. The extruder die assembly of claim 1, wherein the actuator comprises an expansible fluid working chamber provided at least in part between the support member and the inner die member, the inner die member including a hydraulic reaction surface, and a supply of hydraulic fluid being controllably delivered to the expansible fluid working chamber to impart reaction force to the hydraulic reaction surface to move the inner die member relative to the outer die member.

3. The extruder die assembly of claim 2, wherein the die support body includes a first engagement surface configured to mate in engagement with the inner die member to limit movement of the inner die member from engaging the outer die member as hydraulic fluid is delivered into the expansible fluid working chamber so as to provide for the annular die gap having a minimum dimension.

4. The extruder die assembly of claim 2, wherein the die support body includes a second engagement surface configured to mate in engagement with the inner die member to limit movement of the inner die member away from the outer die member as hydraulic fluid is released from the expansible fluid working chamber so as to provide for the annular die gap having a maximum dimension.

5. The extruder die assembly of claim 1, wherein the outer die lip and the inner die lip each comprise circumferential die lips that cooperate to provide a cylindrical annular die gap.

6. The extruder die assembly of claim 1, further comprising a die shaft provided coaxially within the inner die member and at least one slidable seal provided between the die shaft and the inner die member to provide for sealable, sliding interaction therebetween.

7. The extruder die assembly of claim 6, wherein the actuator comprises an axial fluid delivery port extending through the die shaft and a radial port extending from the axial port, and further comprising an expansible working chamber provided between the inner die member relative to the die shaft.

8. The extruder die assembly of claim 4, further comprising at least one shim configured for mounting between the second engagement surface and the inner die member to adjust the maximum dimension for the annular die gap.

9. The extruder die assembly of claim 1, wherein the die support body comprises at least one die body, a spider core, a spider arm configured to carry the spider core within the die body and a die shaft extending from the spider core.

10. A method of extruding thermoplastic foam, comprising:
providing a stationary outer die, a movable inner die configured to cooperate with the outer die to provide an annular die gap therebetween, and an actuator for moving the inner die relative to the outer die;
moving the actuator to a first position with the inner die positioned relative to the outer die to provide the die gap in a sheet forming operating position; and
responsive to a need to clean the die gap, moving the actuator to a second position further away from the outer die to provide the die gap in a die gap cleaning position.
